(19) United States
(12) Patent Application Publication
(10) Pub. No.: US 2012/0065957 A1
(43) Pub. Date: Mar. 15, 2012

(54) INTERPERSONAL COMMUNICATIONS DEVICE AND METHOD

(76) Inventor: Werner Jungblut, Singapore (SG)

(21) Appl. No.: 13/319,008

(22) PCT Filed: May 8, 2009
(86) PCT No.: PCT/SG2009/000167

§ 371 Date: Nov. 4, 2011

(51) Int. Cl. G06F 17/28

(52) U.S. Cl. 704/3

(57) ABSTRACT

Device for converting a source language message into a target language message is disclosed. An embodiment of the device includes an input, a controller, and an output. The input receives separately entered source language phrases as the source language message for a user. The controller obtains, for each entered source language phrase, a stored source language phrase having a correlation with a respective entered source language phrase, each stored source language phrase having a predefined association with an object encoding a target language phrase. The output outputs the target language message as a signal communicating a sequential arrangement of the target language phrases encoded by the objects associated with the obtained stored source language phrases. A method of converting a source language message into a target language message is also disclosed.

FIELD OF INVENTION

The present invention relates to communication devices for interpersonal communications. In a typical application an embodiment of the present invention may be used to allow interpersonal voice or text communication between a source language user and a target language user.

### BACKGROUND OF THE INVENTION

In today's modern world, the ability to effectively communicate with people from different countries is becoming increasingly important. With globalization, people are increasingly required to communicate with people of diverse cultures and language.

In interpersonal communication involving two parties having a different native or source language, and where neither party is fluent in the other's language, a communication aid may be used to assist with translating the two different languages so as to improve communication between the parties.

One example of a simple communication aid is a book or electronic language translator which provides a listing or library of key words and phrases for a user to manually look-up and then, in some cases, attempt to pronounce or display to the other party. Unfortunately, such aids are impractical and thus may hinder, rather than improve, communication between the parties since they require the user to look up or search for the word or phrase that they would like to communicate to the other party.

An attempt to addresses the practical difficulties associated with a manual look-up involves deploying a more sophisticated electronic translator which accepts a voice input from a user and then attempts to match that input with a predetermined translated phrase. For example, PCT/US00/32019 discloses an embodiment of a voice controlled translation device having a translation function which allows the device to accept a voice input phrase from a user in the user's source language, and which then repeats the input phrase as a target language phrase. The device disclosed in PCT/US00/32019 must be trained to correlate the voice input phrase with a stored source language phrase prior to performing the translation. In addition, the device performs a phrase-by-phrase translation approach, and is thus unable to translate messages comprising multiple phrases. Unfortunately, a phrase-by-phrase translation approach may fragment communication between the parties.

Published international patent application PCT/EP2007/055452 discloses a first device for receiving a first voice message in a source language and checking whether a phrase in the received message is contained in a phrase glossary translated into an intermediate meta-language. If the received message is contained in the phrase glossary, the device encodes the received phrase into the intermediate meta-language and communicates, to a second device, a signal encoded in the intermediate meta-language for conversion into the language known to the second user. On the other hand, if the phrase is not contained in the phrase glossary, the first device translates the first voice message on a word-by-word basis into the intermediate meta-language. Practically speaking, the first device is somewhat inflexible in operation since efficient operation of the device depends on locating an exact match between the phrase of the first voice message and a phrase of the phrase glossary in the first device. If an exact match is not found the first device performs a computationally intensive automated translation. In addition, such an automated translation means that the first user is uncertain whether the translation was a sensible one.

Published international patent application PCT/KR2006/000923 discloses a method and device for providing a translation service using a mobile communications terminal. The device described in PCT/KR2006/000923 includes a sentence recognizer for recognizing Korean sentences or keywords which are similar to an input sentence or word. The device is capable of providing either a single sentence or single translation of a single input English sentence or word into the Korean language. However, such an approach may not be conducive to fluent conversation between parties, particularly in circumstances involving multiple sentences. In addition, the method proposed in PCT/KR2006/000923 is somewhat inflexible in that it only permits the user to select a translation suggested by the device. In other words, the user is unable to manipulate or modify the information contained translation to any extent, other than by selecting a different translation.

There is a need for a device which improves the fluency and continuity for information exchanges which involve translating a source language into a target language. There is also a need for a device which provides improved flexibility in operation.

### SUMMARY OF THE INVENTION

The present invention provides a device for converting an input source language message into a target language message, the device including:

an input for receiving separately entered source language phrases as the source language message for a user;

a controller for obtaining, for each entered source language phrase, a stored source language phrase having a correlation with a respective entered source language phrase, each stored source language phrase having a predefined association with an object encoding a target language phrase; and

an output for outputting the target language message as a signal communicating a sequential arrangement of the target language phrases encoded by the objects associated with the obtained stored source language phrases.

References to the term “source language phrase” where used throughout this specification are to be understood as denoting an expression, in the source or native language of the user, consisting of one or more words forming a grammatical constituent of a sentence. On the other hand, references to the term “target language phrase” are to be understood as denoting an expression, in the target or foreign language, consisting of one or more words forming a grammatical constituent of a sentence.

The device typically includes a mobile computing device, such as a mobile phone, personal digital assistant (PDA), notebook computer, laptop computer, or a customized programmed device equipped with a suitable operating system and processing infrastructure.

Embodiments of the present invention based on a mobile computing device may be well suited to applications involving face-to-face communications which would permit a single device to be passed or shared between multiple users of different languages. In such an embodiment, the target language message may be communicated graphically or aurally. For example, communication of the target language message may involve a text based output in the target language, or an audible signal (for example, synthesized or pre-recorded speech), or a combination thereof.

It is to be appreciated that use of mobile or other embodiments of the present invention could equally involve electronic communication between plural devices of a signal containing information encoding the target language message, as opposed to sharing a single device, in which case such use may be independent of the proximity of the plural devices in relation to each other. By way of example, a first user may operate the device to communicate to a second device a signal containing information encoding the target language message via a suitable communications channel. A suitable communications channel may include email, SMS, Bluetooth, infrared (IR), ZigBee, or the like.

It also will thus also be appreciated that embodiments of the present invention are not restricted to face-to-face communication. It is also possible that in other applications the device(s) may not be a mobile device. For example, it is envisaged that embodiments of the present invention will find application in a diverse range of electronic forms of interpersonal communications, such as, short message service (SMS) messaging, email, instant messaging services, web-based chat forums, on-line gaming, and the like which can be implemented equally well on mobile or desktop based devices. Thus, although preferred embodiments of the present invention may be implemented as mobile computing devices, it is to be appreciated that other embodiments may be implemented using non-mobile computing devices, such as desktop computers.

The input may include any suitable input means for entering each source language phrase. Suitable input means may include, for example, a keypad, tracker-ball, mouse, touch panel, keyboard, tablet, or microphone with suitable input interface drivers.

In an embodiment in which the input includes a tactile input, such as a keypad, tracker-ball, mouse, touch panel, keyboard, or tablet, each source language phrase may be entered by selecting or entering source language elements, such as characters, numbers, or words comprising the source language phrase, or objects (such as symbols, “hot-keys”, codes, acronyms or abbreviations) associated with, or representing, or phonetically equivalent to the source language elements comprising the phrase.

In an embodiment in which the input includes a microphone, the controller will include suitable processing infrastructure and software (such as voice recognition software) for receiving and processing a speech input containing an entered source language phrase. In such an embodiment, the controller's processing infrastructure and software may be configured to convert the speech input into a suitable form, such as a file including encoded data, for correlating the entered plural source language phrase with one of plural stored source language phrases. For example, in an embodiment the controller's processing infrastructure and software is configured to convert the speech input into an audio file (such as an mpeg3 file, a windows media file or the like) and to correlate an audio signature of the file with the audio signatures of the stored source language phrases to select, for each entered source language phrase, a stored source language phrase having a correlation which exceeds a minimum threshold value of correlation. In this respect, references to the term “audio signature” throughout this specification are to be understood as denoting a digital code generated by processing an audio waveform. Suitable speech recognition techniques and software for implementing those techniques would be well known to a skilled reader.

In another embodiment, the controller's processing infrastructure and software may be configured to convert the speech input into a machine readable code, such as a binary, ASCII, or word processing file, and then correlate attributes of the machine readable code with corresponding attributes of the stored source language phrases to select, for each entered source language phrase, a stored source language phrase having a correlation which exceeds a minimum threshold value of correlation or which has the highest value of correlation. Such attributes may include, for example, the number of characters and/or words, the sequence of words, or an object indication number. Correlating an entered source phrase with a stored source language phrase may involve, for example, calculating an object indication number in the form of a score or value indicative of a measure of correlation between the entered source phrase or section and each stored source language phrase and expressing the correlation in terms of a percentage value.

By way of example, obtaining a stored source language phrase for an entered source language phrase may involve selecting from a library, such as a database containing plural stored source language phrases, the stored source language phrase having the highest correlation in number of matching words, such as correctly matching spelt words. In the event that the database contains more than one stored source language phrase with an equal number of matching words, the selection may then involve selecting the stored source language having a higher correlation of words in a sequence which corresponds with a sequence of the words in the entered source language phrase. In the event that more than one stored source language phrase fulfils that correlation criteria, the stored source language phrase with the smallest object indication number may then be selected.

Each entered source language phrase may comprise, for example, a complete single sentence, or an arrangement of partial or incomplete sentences. Thus although in some embodiments each entered source language phrase will comprise a single complete sentence, it is to be appreciated that in other embodiments the entered source language phrase may comprise a partitioned or incomplete sentence, such as a partial sentence.

In terms of a partitioned sentence, in some embodiments the input may permit a user to enter as source language phrase with one or more markers identifying a partition in the source language phrase. In such an embodiment, the partition marker(s) may segregate a character(s), word, or clause from the remainder of the source language phrase. For example, the partition marker(s) may be used to segregate a noun or a noun clause in the source language phrase. Typically, the marker(s) will be positioned in the phrase at a location which corresponds with the location of the segregated character(s), word, or clause or the like. Thus in embodiments which permit a user to enter a source language phrase with one or more markers identifying a partition in the source language phrase, the source language phrase will comprise plural sections, namely, one or more marked section and one or more unmarked sections.

In view of the above, correlating an entered plural source language phrase with a stored source language phrase may involve selecting a stored source language phrase having a correlation with the entire entered source language phrase. Alternatively, in embodiments which accept partitioned source language phrases, the correlation may involve selecting plural stored source language phrases, each having a correlation with respective marked and unmarked sections of the entered source language phrase.

The device may include a memory storing plural stored source language phrases and/or the associated objects. In such an embodiment the plural stored source language phrases and/or the associated objects may be stored, for example, in a database in device memory, such as volatile or non-volatile device memory.

Alternatively, the device may include communications infrastructure for accessing an external data storage device storing the plural stored source language phrases and/or the associated objects. The data storage device may be connected directly or indirectly to the device via a suitable communications interface. For example, the data storage device may comprise solid state memory (such as flash, SRAM, or DRAM memory), a hard disk drive, or a removable media drive (such as a CD drive), which interfaces with the device via a USB interface or other suitable interface.

In another embodiment, the external data storage device may be located on a server, or another networked entity type, which is available for communication with the communications infrastructure of the device via a suitable communications network.

The communications network will vary according to the device's communications infrastructure and capabilities and may include, for example, a mobile telephony data communications network (such as a GPRS, or 3G based communications network), a personal area network (such as a Bluetooth or ZigBee communications network), a local area network (LAN), a wide area network (WAN) or the like. The communications infrastructure may support wired or wireless data communications, although in some applications wireless communications is preferred.

The communications network may be configured as a client-server based network or a peer-to-peer (P2P) network.

In preferred embodiments the software functionality for obtaining a source language phrase having a correlation with a respective entered source language phrase will be embedded on the device.

Each stored source language phrase will have a predefined association with one or more objects encoding a respective target language phrase. Indeed, each stored source language phrase may be associated with one or more objects encoding a respective target language phrase in one or more respective languages. An object may include, for example, an audio file, a text file, a binary file or any other suitable object which is decoded to provide the encoded target language phrase output.

The predefined association between the stored source language phrases and the one or more objects may be, for example, defined as a relationship in a single relational database containing each plural stored source language phrases and the associated one or more objects encoding a target language phrase. Alternatively the association may be defined in terms of a relationship between plural stored source language phrases contained in a first database, and plural respective objects for respective target language phrases in a second database or at another identified memory location. Such an embodiment may involve, for example, indexing an identifier retrieved from the first database for a stored source language phrase into the second database to retrieve, or identify the memory location of, the associated object encoding a target language phrase.

An embodiment may include a second input for receiving, from the user, an input indication of the user's acceptance of each obtained source language phrase as an accepted source language phrase, and for communicating only the source language phrases in the sequential arrangement.

The second input may be of any suitable type. In an embodiment, the second input includes a tactile input, such as a mouse, keyboard, keypad, touch screen, joystick, or the like, for accepting the input indication from the user. In such an embodiment the user input of the input indication may be in response to a visual prompt or graphical element displayed on a display of the device. Such a visual prompt or graphical element may include, for example, an icon, or a graphical-user-interface (GUI) control such as a dialog box, check-box, tick-box, list-box, or the like.

In another embodiment, the second input may include a microphone and suitable processing infrastructure and software on board the device for accepting voice commands from the user.

It is possible that the second input may be the same input as the first input.

The controller preferably constructs the sequential arrangement as an output queue comprising the objects associated with the accepted source language phrases in order of acceptance of the accepted source language phrases. The output queue may then be used to output the target language message in the form of a contiguous arrangement of the target language phrases encoded by the associated objects.

In an embodiment, the output target language message comprises separate pre-recorded audio messages for each target language phrase. Thus, for a language message which comprises plural target language phrases, the target language message may comprise a series of pre-recorded audio messages, one for each target language phrase which has been queued according to the order of the accepted source language phrases.

According to another embodiment of the present invention there is provided a method of converting a source language message into a target language, the method including:

a device receiving separately entered source language phrases as the source language message for a user;

the device obtaining, for each entered source language phrase, a stored source language phrase having a correlation with a respective entered source language phrase, each stored source language phrase having a predefined association with an object encoding a target language phrase; and

the device outputting the target language message as a signal communicating a sequential arrangement of the target language phrases encoded by the objects associated with the obtained stored source language phrases.

The present invention also provides a computer software readable media including computer program instructions which are executable by a device for converting a source language message into a target language message to cause the device to:

receiving separately entered source language phrases as the source language message for a user;

obtain, for each entered source language phrase, a stored source language phrase having a correlation with a respective entered source language phrase, each stored source language phrase having a predefined association with an object encoding a target language phrase; and

output the target language message as a sequential arrangement of the target language phrases encoded by the objects associated with the obtained stored source language phrases.

The present invention also provides a device for converting a source language message into a target language message, the device including:

an input for receiving the source language message, the source language message comprising one or more partitioned source language phrases, each partitioned source language phrase including one or more markers identifying partitions segregating source language elements of the source language phrase;

a controller:
obtaining for each source language element, a stored source language element having a correlation with each respective entered source language element, each stored language element having a predefined association with an object encoding a target language element;
for each partitioned source language phrase constructing a source language phrase from the respective obtained stored source language elements; and

an output for outputting the target language message as a signal communicating a sequential arrangement of the target language elements encoded by the objects associated with the stored source language elements of the constructed source language phrase.

The present invention also provides a method of converting a source language message into a target language message, the method including:

a device receiving the source language message, the source language message comprising one or more partitioned source language phrases, each partitioned source language phrase including one or more markers identifying partitions segregating source language elements of the source language phrase;

the device:
obtaining for each source language element, a stored source language element having a correlation with each respective entered source language element, each stored language element having a predefined association with an object encoding a target language element;
for each partitioned source language phrase constructing a source language phrase from the respective obtained stored source language elements; and
outputting the target language message as a signal communicating a sequential arrangement of the target language elements encoded by the objects associated with the stored source language elements of the constructed source language phrase.

The present invention also provides a method of two-way communication between a first user and a second user of different languages, the method including:

entering into a device an initial message in the language of the first user, the initial message comprising one or more partitioned phrases, each partitioned phrase including one or more markers identifying partitions segregating language elements;

the device outputting a first output message as a sequential arrangement of objects having a predefined association with stored language elements having a correlation with the segregated language elements, each object encoding a language element in the language of the second user; and

the second user receiving the output message and operating the device to enter a reply message in the language of the second user for communication to the first user in the language of the first user, the reply message comprising one or more partitioned reply phrases, each partitioned reply phrase including one or more markers identifying partitions segregating language elements of the reply phrase;

the device outputting a second output message as a sequential arrangement of objects having a predefined association with stored language elements having a correlation with the segregated language elements of the reply phrase, each object encoding a language element in the language of the first user.

Some or all of the above software functionality for implementing the above features may be embedded on the device or it may instead be hosted on, or distributed across, one or more other processing devices in communication with the device. For example, the device may include a “plug-in” or interpreter for interpreting code which has been pushed to the device from a server, or pulled by the device from a server. Thus, the software may be a client side or server side based. In distributed software architectures the software functionality may be implemented as a web-based service.

The present invention may reduce the difficulties associated with interpersonal communication between people of different native languages. In particular, the present invention provides may improve the fluency and continuity for information exchanges which involve translating a source language into a target language. The present invention may also provide improved flexibility in operation in an applications requiring language translation.

### BRIEF DESCRIPTION OF THE DRAWINGS

The present invention will now be described in relation to preferred embodiments as illustrated in the accompanying drawings. However, it is to be understood that the following description is not to limit the generality of the above description.

FIG. 1 is a block diagram for a device in accordance with a first embodiment of the present invention;

FIG. 2 is a block diagram for a device in accordance with a second embodiment of the present invention;

FIG. 3 is a block diagram of a system comprising multiple devices according to an embodiment of the present invention;

FIG. 4 is a block diagram of a networked system comprising multiple devices according to an embodiment of the present invention;

FIG. 5 is a screen layout of an input interface suitable for use with an embodiment of the present invention;

FIG. 6A and FIG. 6B depict a sequence of screen layouts illustrating an example application of a device according to embodiment of the present invention;

FIG. 7 is screen layout illustrating another example application of a device according to embodiment of the present invention;

FIG. 8A and FIG. 8B depict a flow diagram of a method in accordance with an embodiment of the present invention;

FIG. 9 is sequence of screen layouts illustrating another example application of a device according to embodiment of the present invention; and

FIG. 10 is a screen layout illustrating another example application of a device according to embodiment of the present invention.

### DETAILED DESCRIPTION OF AN EMBODIMENT

Embodiments of the present invention convert an input source language message comprising one or more source language phrases into a target language message. The source language will be a first language, such as English, and the target language will be a different language to the first language, such as German. Embodiments of the present invention may provide the capability for a user to select from multiple source and target languages.

One embodiment of the present invention involves a mobile device which receives an entered input source language message as a speech input and outputs the target language message as an audio output comprising concatenated audio file objects, such as mpeg3 files. Each separate audio file is selected by the device based on a correlation between each of the one or more entered source language phrases of the input source language message and a respective stored source language phrase having a predefined association with an audio file object encoding a target language phrase. The device outputs, in order of user acceptance of the selected source language phrases, a target language message comprising the target language phrases encoded by the audio file object associated with each accepted source language phrase. In other words, the target language message may include plural target language phrases.

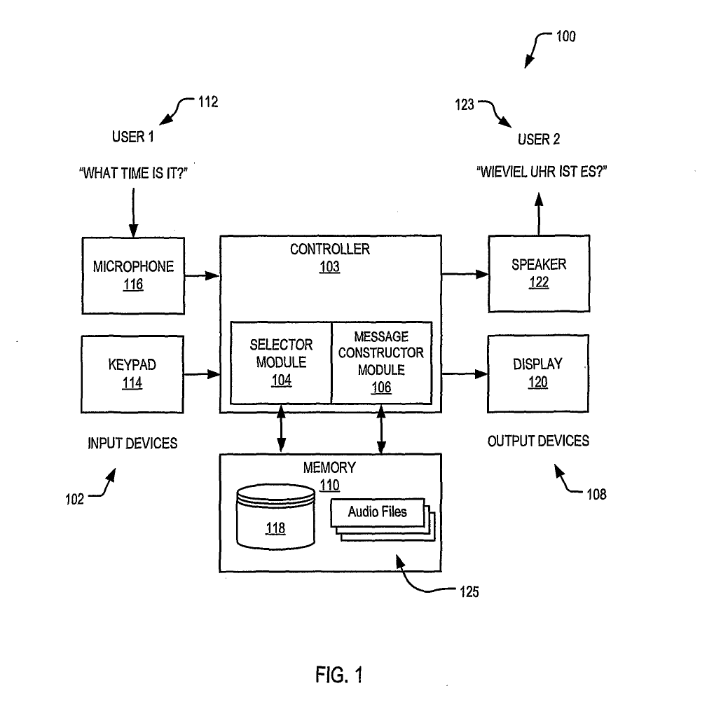

Referring now to FIG. 1, there is shown a block diagram for a device 100 according to a first embodiment of the invention for converting a source language message into a target language message. The device 100 includes input devices 102 (shown as keypad 114 and microphone 116), a controller 103, output devices 108 and a memory 110, which may be device memory or external memory. For convenience, the controller 103 is shown as including functional blocks for a selector module 104 and a message constructor module 106 representing two particular functions conducted by the software, hardware and/or firmware of the controller 103 which will be described in more detail below.

The input devices 102 enable a user 112 to separately enter plural source language phrases into the device 100. In order to reduce memory and processing requirements, it is preferred that each entered language phrase consist of a short sentence in the source language. In the example depicted in FIG. 1, the entered language phrase is “What time is it”.

The device 100 depicted in FIG. 1 includes plural input devices 102 in the form of a keypad 114 and a microphone 116. However, it is to be appreciated that the illustrated input devices 102 are for example purposes only to assist with the explanation that follows. Thus, it is possible that other embodiments of the present invention may use a different number, type and/or arrangement of input devices 102 without departing from the scope of the present invention. By way of example, other suitable input devices may include, but not be limited to, a keyboard, tracker-ball, mouse, touch panel, tablet or the like.

In the embodiment illustrated, each of the plural source language phrases may be entered into the device 100 by the user 112 via the keypad 114 as a text input, or as a speech input via the microphone 116.

Typically, each source language phrase is entered separately as a continuous sentence. However, as will be described in more detail later, some embodiments of the present invention permit partitioned sentences to be used.

For each entered source language phrase, the selector module 104 of the controller 103 selects a stored source language phrase having a correlation with a respective entered source language phrase. The selector will typically be implemented as a software module or function which is executable by a processing unit (not shown) of the controller 103.

In the embodiment illustrated, the stored source language phrases are stored in a first database 118 in memory 110 of the device 100 as text entries. Thus, in the depicted embodiment the first database 118 contains a library of source language phrases which are available for correlation, and thus selection, in response to an entered source language phrase. By way of example, an embodiment may include a library of about 50,000 source language phrases in the first database 118, in which case the first database 118 would contain 50,000 indexable text entries. Of course, as will be appreciated, the number of stored source language phrases may vary according to the memory and processing capability of the device 100. A different first database 118 will typically be provided for each different source language supported by the device 100. Thus, the device 100 may be able to access multiple first databases 118, with the actual database 118 accessed depending on the source language selected by the user 112. Thus embodiments of the device 100 may include a source language selector which is operable by the user 112 to select the source language for the source language message. The source language selector may include, for example a particular button or key-press, or another user activatable control.

In the present example, the first database 118 also identifies associations between the stored source language phrases and one or more objects encoding a target language phrase for output in a target language message. Different sets of the one or more objects encoding a target language phrase will typically be provided for each target language which is able to be selected by the user 112. Hence, the first database 118 may identify associations between each of the stored source language phrases and multiple respective objects, wherein each associated object encodes a target language phrase in a different target language. Typically, different sets of objects will be provided for each different target language which is able to be output by the device, with the actual set of objects accessed depending on the target language selected by the user 112.

Each object may comprise machine readable information, of a suitable type, which is decodable by the device 100 to output the encoded target language message. Thus, for each stored source language phrase the database 118 will typically define a predefined association with electronic information encoding a corresponding target language phrase.

As will be described in more detail later, the electronic information encoding a corresponding target language phrase may be in the form of an audio file object (such as an mpeg3 file) encoding pre-recorded speech, a text file, or another suitable form.

As will be appreciated, for different embodiments the database 118 may contain a different number of stored source language phrases and thus the device 100 may also store a different number of associated objects encoding a target language phrase. Hence, for example, an embodiment that includes a library of about 50,000 source language phrases in the first database 118 will typically also include 50,000objects encoding 50,000 target language phrases, assuming that each stored source language phrase has a unique relationship with an object encoding a target language phrase. In other words, one embodiment provides objects encoding 50,000 target language phrases as pre-recorded speech wherein each object comprises a separate audio file object having a unique predefined association with a stored source language phrase.

It is possible that a target language phrase may have a predefined association with more than one source language phrase, in which case, in the above example, less than 50,000 objects would be required. In other words, each object encoding a target language phrase may have an association with multiple source language phrases. Such may be the case, for example, where a target language phrase has semantic equivalence with different source language phrases.

The embodiment depicted in FIG. 1 stores the objects in the form of electronic information encoding each target language phrase as a respective pre-recorded audio file object 125. In preference, each audio file object 125 comprises a digital recording of a human voice pronouncing the respective target language phrase. Although in the present example the audio file objects 125 comprise a digital recording of a human voice, it is possible that other embodiments may employ computer generated speech. However, for clarity a digital recording of a natural human voice is preferred.

In the present example, selecting a stored source language phrase having a correlation with a respective entered source language phrase involves correlating attributes of the entered source language phrase with corresponding attributes of the stored source language phrases to select, for each entered source language phrase, a stored source language phrase having a correlation which exceeds a minimum threshold value of correlation, or which has the highest value of correlation.

Typically, the correlation will be measured in terms of the extent to which the entered source language phrase “matches” or is “close to” a stored source language phrase, and may be expressed in terms of a percentage or other suitable indices or measure. In the present case the correlation involves a multi-level approach initially involving indexing into the database 118 to select the stored source language phrase(s) having the highest correlation in number of correctly spelt words. In the event that the database 118 contains more than one stored source language phrase with an equal number of matching words, the selection then checks the word sequence and selects the stored source language phrase(s) having the higher correlation of words in a sequence which corresponds with a sequence of the words in the entered source language phrase. In the event that more than one stored source language phrase fulfils that correlation criteria, the stored source language phrase with the smallest object indication number or index may then be selected.

As a simple example, say the user 112 enters the source language phrase “I want to sing a song”. In this example, the device 100 indexes the database 118 to obtain a stored source language phrase having a correlation with the entered source language phrase. In this example, and for ease of explanation, the database 118 contains only four stored source language phrase(s), namely:
1. “I want to sing”
2. “I like this song”
3. “Can you sing a song to me?”
4. “I want to sing today”

In this case, the first, third and fourth phrases each include four words which are contained in the entered source language phrase, whereas the second phrase contains only two matching words and thus has the lowest correlation with the entered source language phrase. To continue with the correlation process, the device 100 checks the order or sequence of the words contained in the first, third and fourth phrases using a suitable process. In this example, the order or sequence of words in the third phrase is less accurate, and thus the third phrase does not correlate with the entered source language phrase to same extent as the first and fourth phrases which, in term of the number of matching words, correlate equally with the entered source language phrase. However, in this example, the device 100 will obtain the first phrase (that is, “I want to sing”) since it has a lower index number (that is, index number 1) than the 4th record (that is, index number 4).

It will be appreciated that although in the above example the correlation process involves obtaining a single stored language phrase from the database 118 it is also possible that obtaining a stored language phrases involves the device 100 obtaining multiple stored language phrases having a correlation with the entered source language phrase and prompting the user 112 to select or accept one of the selected multiple stored language phrases as the “closest matching phrase”. In other words, in some embodiments the user 112 may select the stored source language phrase having a desired correlation with the entered source language phrase from a “list” of possible stored source language phrase obtained by the device 100.

Returning now to FIG. 1, in the embodiment illustrated, the controller 103 includes or utilises suitable processing infrastructure and software for receiving and processing each entered source language phrase as either a text input entered (via the keypad 114) or an audio signal received from the microphone 116. It is to be appreciated that it is not essential that the device 100 includes infrastructure and software for receiving and processing text inputs and audio signals since in some embodiments the device 100 may be configured to receive and process only text inputs (in which case, the microphone 116 would not be required) or only audio input signals (in which case, the keypad 114 or other tactile input would not be required).

In embodiments including a microphone 116 for inputting an audio signal representing a “speech input” for the entered source language phrase, the controller's 103 processing infrastructure and software will be configured to convert the speech input into a suitable electronic form, such as a file including encoded data, suitable for correlating each entered plural source language phrase in the speech input with one of plural stored source language phrases.

In the present case, the controller's 103 processing infrastructure and software is configured to convert the speech input into a text file comprising text derived from the speech input, and to correlate that text with the text of the stored source language phrases to select, for each entered source language phrase, a stored source language phrase having a correlation which exceeds a minimum threshold value of correlation, or which provides the highest value of correlation.

In some embodiments it is possible that the controller's 103 processing infrastructure and software may be configured to analyse the audio “signature” of an audio signal for a complete sentence entered as a speech input and to then divide that sentence into individual language elements (such as words) by locating correlating “fractions” from a database containing a library of electronic files representing the audio signatures of plural language elements. The controller 103 may then convert the input audio signal into a text output for display to the user as a sentence construction, so that the user 112 can confirm that the device 100 has captured the entered source language phrase correctly before attempting to correlate, via the selector module 104, the sentence construction with a stored source language phrase in the database 188.

In an embodiment including a keypad 114, or other suitable tactile input device, the controller's 103 processing infrastructure and software may be configured to convert a text input into a machine readable code, such as a binary, ASCII, or word processing file. Attributes of the machine readable code are then correlated, via the selector module 104, with corresponding attributes of the stored source language phrases to obtain, via a selection process, for each entered source language phrase, a stored source language phrase having a correlation which exceeds a minimum threshold value of correlation.

The selected stored source language phrase may be identical with the entered source language phrase. However, it is also possible that the selected stored source language will be similar to, but not identical with, the entered source language phrase. Typically, the selected stored source language will be closest “match” to the entered source language phrase which is available in the first database 118.

In the embodiment illustrated in FIG. 1, the input device(s) 102 permit a user 112 to accept or decline a selected stored source language phrase for output as a target language phrase in the target language message. In the present case, following entry of each entered source language phrase, the device 100 outputs the selected stored source language phrase to the user 112 for acceptance. In the embodiment illustrated in FIG. 1, each selected stored source language phrase is output in the form of a text display on the display 120 for the user 112 to accept or decline using the input device 102. Acceptance may be indicated, for example, by entering a designated keystroke on the keypad 114, or as a speech input via the microphone 116.

Following acceptance of one or more selected stored source language phrases the user 112 may operate the input devices(s) 102 to activate the message constructor module 106 of the controller 103 to construct the target language message as a signal for communicating a sequential arrangement of the target language phrases encoded by the objects associated with the obtained stored source language phrases. In this example, the sequential arrangement depends on the order of acceptance of the accepted source language phrases.

In the present example, the signal is communicated as an audio output via speaker 122 by “playing” the audio file objects 125 having a predefined associated with each accepted source language phrase.

Thus, in this example the construction of the target language message by the message constructor module 106 involves queuing the audio file objects 125 associated with each accepted source language message, in order of acceptance. However, in other embodiments each target language phrase(s) of the target language message may be output via display 120 as a text output. Typically, the target language message would be output to a second user 123 who speaks and/or reads the target language. It will thus be appreciated that the target language message may be output as either an audible or visible message.

The above described embodiment of the present invention may allow a user 112 to translate plural complete sentences simultaneously and thus improve the ability of the user to conduct extended spontaneous “conversation” with another user 123 of a foreign language. Hence, in this embodiment, in use (in other words, during a “conversation”) the first user 112 passes the device 100 to the second user 123 after accepting the selected source language phrases, and the second user 123 activates the device 100 to output the target language message comprising the target language phrases encoded by the objects associated with the selected source language phrases. Again, the target language message may be output in either an audible or visible form.

Another embodiment (hereafter the “second embodiment”) of the present invention receives an entered source language message comprising one or more partitioned phrases identifying one or more source language elements, and outputs a target language message including one or more source language elements encoded by objects associated with an accepted source language element for each identified source language element(s).

Typically, each object having an association with an accepted source language element includes an electronic file encoding a language element in an audio file object, such as an mpeg3 file.

In the second embodiment each accepted source language element may include either a stored source language element(s) which has been selected based on a correlation between the identified source language element(s) and a respective stored source language element(s), or may be entered by the user in the event that a suitable correlation is unavailable. As will be explained below, each stored source language element will typically include an incomplete or partial phrase, a number, a sequence of characters, a word, or symbol or the like.

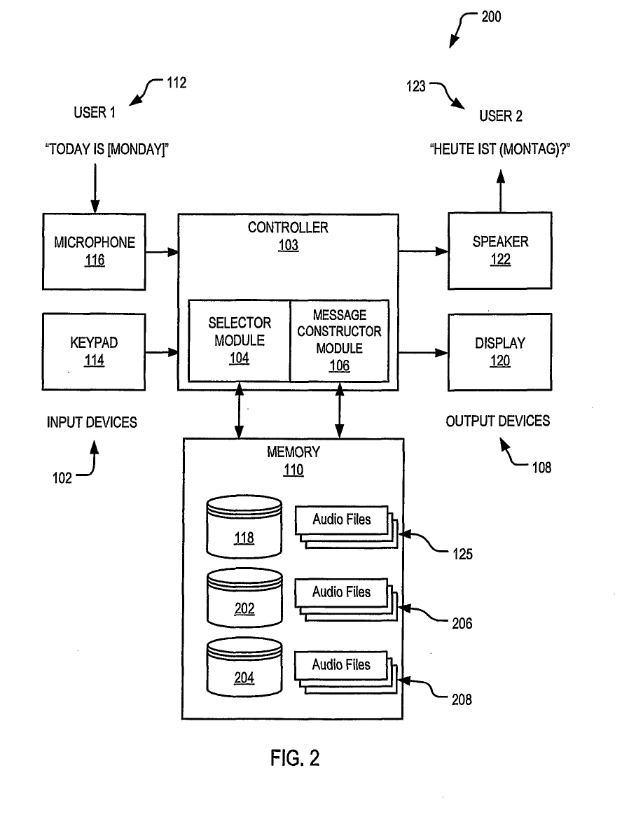

Referring now to FIG. 2, there is shown a block diagram for a device 200 according to the second embodiment of the invention. The device 200 includes input devices 102, controller 103, selector module 104, message constructor module 106, output devices 108 and a memory 110.

The general architecture of the device 200 is generally similar to that of the device 100 of the first embodiment with the exception that the device 200 includes a second database 202 containing a library of particular source language elements, such as “keywords” or “key-clauses” (hereinafter each referred to as “inserts”) in the source language, which may include, for example, names, places, weekdays, months, years, brands, numbers, objects, currency, metrics and the like. In other words, the second database 202 will typically include a library of nouns or noun clauses.

The device 200 also includes a third database 204 containing a library of partial or incomplete phrases in the source language.

The second database 202 stores relationships between the stored “inserts” and objects encoding a corresponding target language “insert”. Thus, each stored “insert” will have a predefined association with an object encoding a corresponding target language insert. In preference, the object encoding a corresponding target language “insert” is an audio file object 206, such as an mpeg3 file. However, it is also possible that the object encoding a corresponding target language “insert” is a text file.

The third database 204 stores relationships between the stored incomplete or partial phrases and objects encoding a corresponding target language incomplete or partial phrase. Thus, each stored source language incomplete or partial phrase will have a predefined association with an object encoding a corresponding target incomplete or partial phrase. In preference, the object encoding a corresponding target language incomplete or partial phrase is an audio file object 208, such as an mpeg3 file. However, it is also possible that the object encoding a corresponding target language “insert” is a text file.

The device 200 permits a user 112 to enter a source language phrase including one or more markers or delimiters identifying a partition or a partitioned area in the entered source language phrase. The marker or delimiter may include, for example, a symbol (such as a bracket symbol) which may be entered as text or as speech in the form of a suitable cue such as by the user saying “insert bracket”.

For the remainder of this specification the term “marker” will be used to denote a marker, delimiter, or other suitable identifier for partitioning an entered source language phrase into plural sections. The marker(s) will segregate a character(s), word, number, or clause of an entered source language phrase from the remainder of the source language phrase, with the remainder thus being an incomplete or partial phrase.

By way of example, the marker(s) may be used to segregate a noun or a noun clause in the entered source language phrase. Thus, typically, the marker(s) will be positioned in the entered source language phrase at a location which corresponds with the location of the segregated character(s), word, or clause or the like.

In the embodiment depicted in FIG. 2 the entered source language phrase may thus comprise plural partitioned sections, for example, one or more partitioned sections comprising a noun or noun clause, and one or more remaining partitioned sections representing the remainder of the entered source language phrase. For convenience, each partitioned section identified using a marker(s) will be denoted as a “marked section” whereas the remaining section(s) will be denoted as an “unmarked section”.

In the embodiment depicted in FIG. 2, the selector module 104 of the controller 103 selects, for each “unmarked” section of the entered source language phrase, a stored source language phrase having a correlation with a respective entered source language phrase using substantially the same approach as that described in relation to the device 100 depicted in FIG. l. However, for the “marked sections” the selector module 104 will undertake a separate correlation process in which it will attempt to correlate each marked section with an “insert” stored in the second database 122.

If suitable correlations exist, the selector module 104 selects the stored insert having a correlation with the “marked section” and the stored source language phrase having a correlation with for “unmarked section”. In other words, the selector module 104 indexes the “unmarked” section of the entered source language phrase into the first database 118 for correlation with a stored source language phrase and the “marked” section into the second database 202 for correlation with a stored “insert”.

In the event that suitable correlations are found, the selected stored source language phrase and the selected stored insert are combined so as to construct a source language phrase for acceptance by the user. In the event that the selector module 104 is unable to locate a stored insert having a suitable correlation with the “marked section”, the device 200 will prompt the user to either enter (in text form) or record (as speech), the word or clause for inclusion in the constructed source language message.

If the constructed source language phrase is acceptable to the user 112 then the user 112 may activate the message constructor module 106 to construct for communication, and in the order of acceptance of the accepted source language phrases, a target language message comprising, for each accepted source language phrase, an associated target language phrase.

In embodiment depicted in FIG. 2, each target language phrase of the target language message is output as a signal communicating the target language message as a sequential arrangement of the target language phrases via speaker 122 by “playing” the associated audio file objects 125, which in this example will include a separate audio file object 125 for each of the “marked” and “unmarked” sections of accepted source language phrase which have been selected for partitioned entered source language phrases.

As described above, the audio file for the “marked” section of an accepted source language phrase may comprise an audio file object 206 having a predefined association (as expressed in the second database 202) with the insert of the accepted source language phrase or it may be an audio file which has been recorded as a speech input from the user 112 in the event that the selector module 104 was unable to locate a suitable correlation with the stored inserts included in the second database 202.

Thus, in this example construction of a target language message by the message constructor module 106 involves queuing the audio file objects 125 associated with each partitioned section of the accepted source language message. However, in other embodiments each target language phrase(s) may be output as the target language message via display 120 as a text output. Typically, the target language message would be output to second user 123 who speaks or reads the target language.

The illustrated second embodiment thus provides three libraries, namely, a first database 118 containing complete stored source language complete phrase, a second database 202 containing “inserts” such as names, places, and the like, and a third database 204 containing incomplete or partial source language phrases.

In this example, in use, if the user 112 enters a source language phrase without markers, the selector module 104 will attempt select a correlating source language phrase from the first database 118 using a similar process to that described earlier in relation to the first embodiment. However, if the user 112 enters a source language phrase with markers, the selector module 104 will attempt to select, for each unmarked section, a stored incomplete or partial source language phrase from the third database 204 which has a correlation with the unmarked sections, again using a similar process to that described earlier in relation to the first embodiment.

For the marked sections, however, the selector module 104 compares the entered source language element within the insert markers with a correlating record from the third database 204. If the selector module 104 cannot find a stored source language element having a value of correlation with the entered source language element which exceeds a predefined threshold value (which may be expressed, for example, as a threshold value which is indicative of an 85% correlation, meaning than at least 85% of letters are matching and are in correct order), the selector module 104 will select the entered source language element. For example, in an embodiment which accepts speech input, the selector module 104 will select, as an entered object, the audio file of the user's speech input, whereas if keyed or written input is used, the selector module 104 will select the letters as entered.

Determining the value of correlation of the stored source language element with the entered source language element may be performed using any suitable process, such as a letter-by-letter comparison.

By way of example, each letter from a record in the database 204 may contribute to a respective fraction of a 100% value of correlation (for example, in a word with five letters each letter may contribute 20%). Thus, in a simple example in which “HOPING” is the entered source language element, and “HOPPING” is a stored language element contained in the database 204, the value of correlation would be determined as 85.7% since the elements share five out of six letters (that is, the letters “H”, “O”, “P”, “I”, “N”, and “G”) which are sequentially correct. On the other hand, the entered source language element “HOPPIGN” would return a match of five out of seven (that is, the letters “H”, “O”, “P”, “I” and “N”), and thus the value of correlation as 71.4%.

It is to be understood that the above examples of determining the value of correlation are not to be taken as limiting, and other suitable techniques for determining the value of correlation would be well within the knowledge of a skilled person.

In the device 200 according to the second embodiment, the message constructor 106 will construct, for each entered source language phrase comprising plural partitioned sections, a constructed source language phrase for acceptance by the user 112. As is clear from the foregoing description, such a constructed source language phrase will include one or more stored incomplete or partial source language phrases selected from the third database 204, and may include either one or more source language elements selected from the second database 202 or as entered by the user 112.

The display 120 may then display a finished constructed phrase to the user so that the user 112 can verify whether the “insert” originated from the second database 202 or whether it instead includes the source language element(s) entered by them.

In the second embodiment illustrated in FIG. 2, during an audio output of the target language message, an object having a predefined association with each incomplete or partial sentence selected from the third database 204 will be included in the target language message at an appropriate location. For example, if the “insert” was located at the end of the entered source language phrase, the object having a predefined association with the accepted incomplete or partial sentence will be located “in front” of the insert.

In addition, in the event that the insert correlated with a stored source language element in the second database 202, the object having a predefined association with the accepted source language element is also located in the appropriate location of the target language message.

In the event that selected insert was a user entered input, the device 200 will output the inserted source language element in the target language message in the source language, either by “playing” the “audio” file created during the input process or by using a text to speech application.

Although the above described embodiments relate to a single device which is passed between users of a different language in order to facilitate communication there between, it is to be appreciated that other embodiments may involve multiple devices which are operable to communicate messages between the devices.

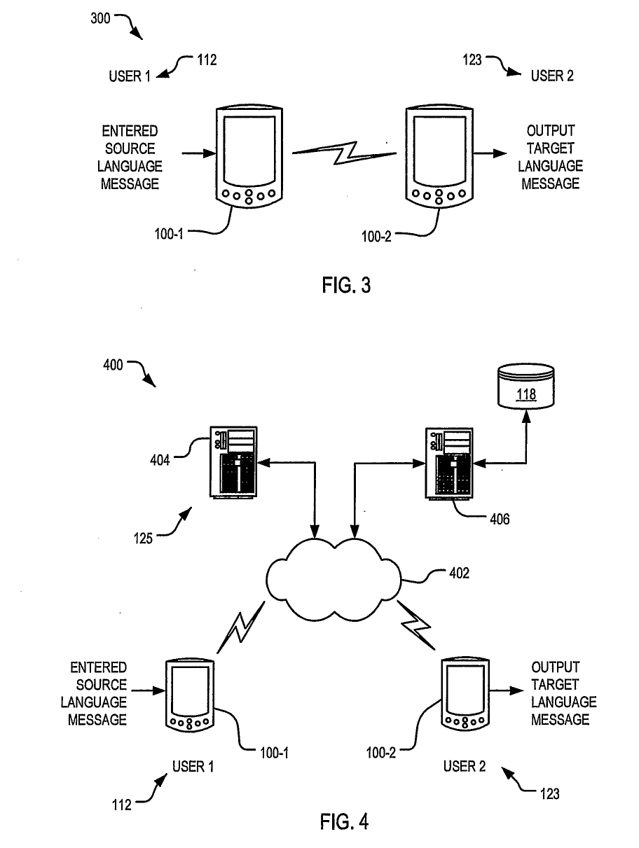

Turning now to FIG. 3 there is shown an example of a communication arrangement 300 which involves a first device 100-1 and a second device 100-2 according to the first embodiment the present invention, although it is equally possible that the depicted arrangement may include devices 200 described in relation to the second embodiment. In this example, each of the devices 100-1, 100-2 further includes a communications transceiver for wireless or wired inter-device communications. The communications may include, for example a communications transceiver which supports Bluetooth, infrared (IR), ZigBee, or the like communications channel.

In the communications arrangement 300 depicted in FIG. 3, after receiving from the first user 112 an input indication of the user's acceptance of each selected source language phrase, the first device 100-1 communicates a signal encoding the target language message to the second device 100-2 for output by the second device 100-2.

FIG. 4 depicts another example of a suitable communications arrangement 400. In the arrangement depicted in FIG. 4 the devices 100-1, 100-2 communicate via a communications network 402 such as mobile telephony data communications network (such as a GPRS, or 3G based communications network), a personal area, a local area network (LAN), a wide area network (WAN) or the like.

In the communications network 400 depicted in FIG. 4, the database 118 and the objects 125 encoding a target language phrase are stored in memory on external data storage devices 404, 406 (shown as servers) respectively which are remote from, but accessible to, the devices 100-1, 100-2. Thus, although the earlier described embodiments involved a device 100 (or device 200) which stored the database 118 (or databases 118, 202, 204) in local memory 110 (ref. FIG. 1 and FIG. 2) it is possible that other embodiments may involve communication with one or more external data storage devices, such as remote servers, which provide the memory requirements for storing the database 118 (or databases 118, 202, 204). It will thus also be appreciated that the databases 118, 202, 204 may be stored on a single server or distributed across multiple servers. Similarly, although the earlier described embodiments involved a device 100 (or device 200) which includes processing and software infrastructure necessary to implement the above described functionality, it will of course be appreciated that a device 100 (or device 200) could equally be a client device in communication with a web-server which implements the above described functionality as a web based implementation.

In view of the above, a device 100/200 in accordance with an embodiment may include a “plug-in” or interpreter for interpreting code which has been pushed to the device from a server, or pulled by the device from a server. Thus, the software infrastructure necessary to implement the above described functionality may be client side or server side based. In a distributed software architecture the software functionality may be implemented as a web-based service.

### Example 1

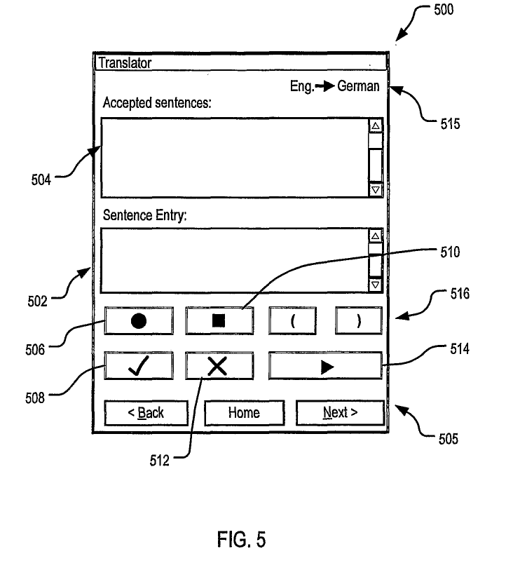

Turning now to FIG. 5 there is shown an example layout of a user interface 500 associated with an input device 102 for operating a device 100/200 in accordance with an embodiment.

The illustrated user interface 500 includes a first display area 502 for displaying entered and/or selected source language phrases, and a second display area 504 for displaying accepted source language phrases. The user interface 500 also includes a control area 505 including controls for entering user operations, such as a “record” control 506, an “accept” control 508, a “stop recording” control” 510, a “decline” control 512, a “play” control 514, and “insert” controls 516.

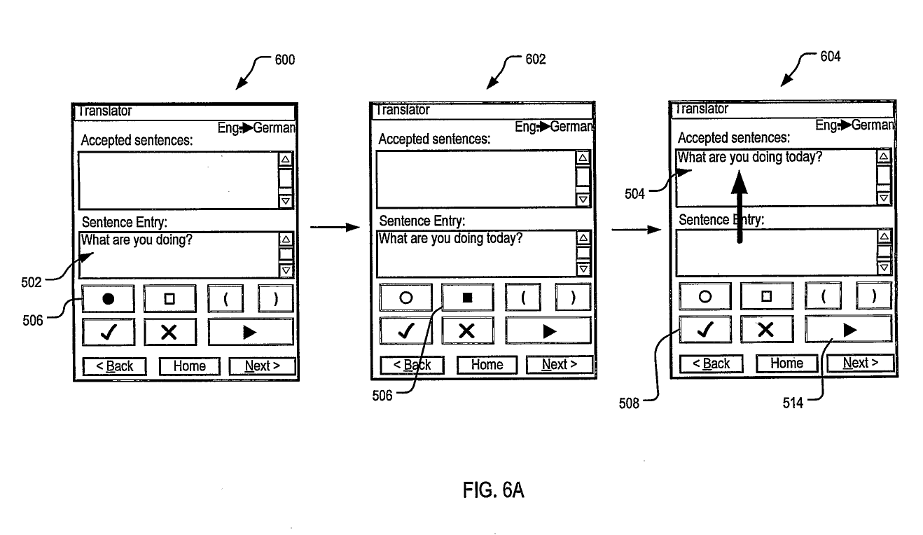

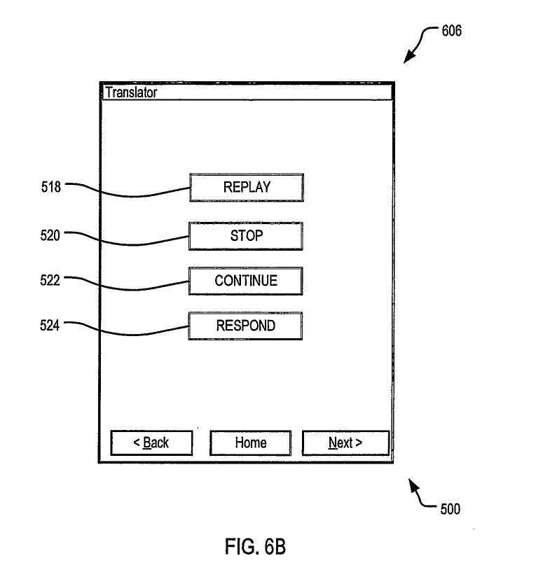

FIG. 6A depicts a sequence of screen shots illustrating an example application of the use of the user interface 500 depicted in FIG. 5 in relation to a device 100 according to the first embodiment. In this example the translation process involves English as the source language and German as the target language as indicted by the translation indicator 515 (ref. FIG. 5). However, it will be appreciated that other languages may be used. Indeed, devices according to some embodiments of the present will provide the user 112 with the ability to select the source and target languages and in so doing configure the device 100/200 to establish the appropriate linkages with the respective databases and objects for the selected source and target languages, for example, databases 118 and objects 125 for device 100 (ref. FIG. 1), and databases 118, 202, 204 and objects 125, 206, 204 for device 200 (ref. FIG. 2). In other words, in the present example, when “English” is selected as the source language and “German” as the target language, database 118 will contain English language phrases having an identified association with objects 125 encoding German language phrases. Similarly, if “German” is selected as the source language and “English” as the target language, database 118 will contain German language phrases having an identified association with objects 125 encoding English language phrases.

With reference now to FIG. 1, FIG. 5, and FIG. 6A, at step 600 a user has operated the “record” control 506 and the “stop recording” control 510, to enter the source language phrase “What are you doing?” as either a speech or text input.

At step 602 the device 100 selects from database 118 a stored source language phrase having a correlation with the entered source language phrase. In this example, the selected stored source language phrase is displayed in the first display area 502 as “What are you doing today” for acceptance by the user as an accepted source language phrase. In this case, the stored source language phrase has a predefined association with an audio file object 125 (ref. FIG. 1) encoding the target language phrase “Was tun Sie heute?”.

At step 604, the user 112 operates the “accept” control 508 to indicate acceptance of the selected source language phrase and thus enter the stored source language phrase as an accepted source language phrase. The accepted stored source language phrase is displayed in the second display area 504.

On activation of the “play” control 514 by the user the device 100 provides an audio output of the target language message “Was tun Sie heute?”. In other words, on activation of the “play” control 514, the device 100 will “play” the object associated with the accepted source language phrase, which in this example includes an audio file object in the form of an mpeg3 file which encodes the target language phrase.

After output of the target language message, and with reference now to FIG. 6B, at step 606 the user interface displays a different arrangement of controls for user activation. In the example shown in FIG. 6B, a “replay” control 518, a “stop” control” 520, a “continue” control 522 and a “respond” control 524 are provided.

The “replay” control 518 enables user to activate a “replay” function for replaying the output of the target language message previously “played”. The “stop” control 520 may be activated to stop a “conversation” and output a query to the user regarding whether the “conversation” should be saved in a “history” file. The “continue” control 522 permits the user to enter further source language messages. The “respond” control 524 permits switching or interchanging of the source language and the target language so that the target language becomes the source language and vice versa. The “respond” control 524 control thus configures the device 100 to permit the recipient of the target language message to respond to the output target language message in their language. A more detailed example of the operation of these controls will be provided later.

### Example 2

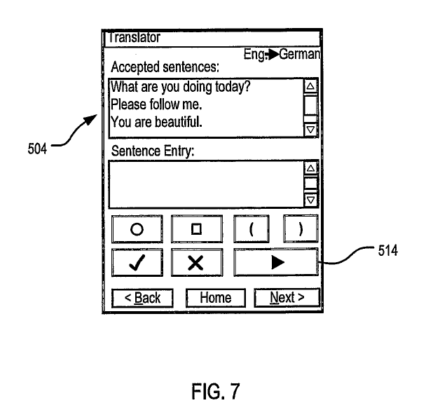

FIG. 7 depicts an example in which plural stored source language phrase have been accepted by repeating the entry process described in relation to FIG. 6 for additional source language phrases “Please follow me” and “You are beautiful”.

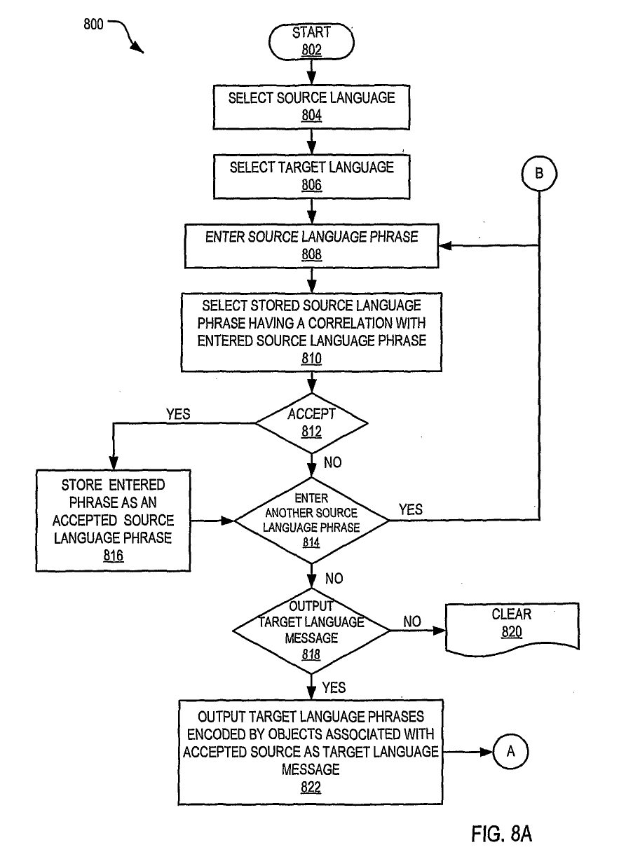

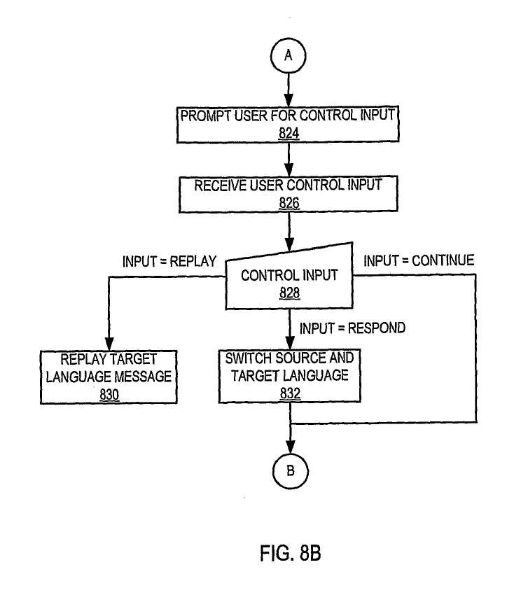

A flow diagram for this sequence is depicted in FIG. 8A and FIG. 8B although in this example steps 802, 804, and 806 have been performed prior to entering the source language phrase at step 808 and selecting, at step 810, a stored source language phrase having a correlation with the entered source language phrase.

In this example, on activation of the “play control” 514 by the user 112 at step 818, and after having accepted the selected stored source language at step 812, the device 100 will output, at step 822, in order of acceptance of accepted source language phrases, target language phrases encoded by the audio file objects 125 (ref. FIG. 1) associated with the accepted source language phrases as the target language message.

The audio file objects, and thus the target language phrases are “played” in the sequence of the acceptance i.e. the first accepted source language phrase will be played first, the second accepted source language phrase sentence second and so on. The device may or may not display anything on the user interface 500 whilst playing the audio file objects 125.

After the audio file objects 125 have been “played”, the device 100 provides the user 112 with the option, at step 824, to select, using the controls described earlier, one of three modes, namely, a “replay” mode in which the target language message will be replayed; a “continue” mode in which the user continues to enter a source language message; or a “respond” mode in which the user that initiated the “conversation” passes the device 100 over to the conversation partner (in other words, the “recipient” of the target language message) and that person now starts entering a message in the target language, which is now treated by the device 100 as the source language. Thus, in this example, after the target language message has been output, the device 100 will provide the user 112 with the options to either continue entering another message (in which case, the source and target languages remain unchanged), or to “interchange” the input and target language so the recipient of the target language message can respond by entering a message in his/her own language. For the latter option, in this example the device 100 is handed to the recipient person who speaks the initial “target” language. However, it will be appreciated that other embodiments may not involve passing a physical device between the users 112, 123 and may instead provide software functionality which permits the recipient user 123 to enter a reply message in the form of a new source language message (that is, a source language message in the language of the user 123) for communication to the user 112 as a target language message in the language of the user 112.

In other words, in the “respond” mode the source and target languages are “interchanged” to permit the recipient user 123 of the target language message (“the response message”) to enter a reply source language message in their language. After the response message has been entered and “played”, the device 100 may then provide the three mode options again, and following the activation of the “respond” mode, the source and target languages revert to their original settings. Switching forward and backwards in this way shall be possible as many times as the conversation partners wish, so as to conduct a “conversation”. As shown in FIG. 8B, the operation of the device 100/200 either proceeds to step 830, 832 or returns to step 808 depending on response received from the user 112 at step 826/828.

In view of the above it will be appreciated that a device in accordance with an embodiment may support two-way communication between a first user 112 and a second user 123 of different native languages.

Although not shown in FIG. 8B, activation of the “stop” control 520 (ref. FIG. 6B) at step 828 provides the user 112 with the option of saving a history file for saving conversations independent from the “source” and “target” languages. In other words, the history file has no connection to any language and may only store, for example, an index from the databases used to form the accepted source language phrases, and/or “verbal inserts”.

If the user 112 selects a history file in a history folder, the user 112 then has the option to either read the stored “conversation” in text form or “play” back the corresponding audio file objects 125. The history files will generally be displayed or replayed in the language the user 112 “selected” after enabling the device 200. In other words, the history file operates independently of the languages in which the conversation was conducted, though it may display the “source” and “target” language. When selecting the “read” option, the device may display an indication when the “conversation” switched from one to the other person (as indicated by a mark recorded each time the “respond” control 524 activated).

### Example 3

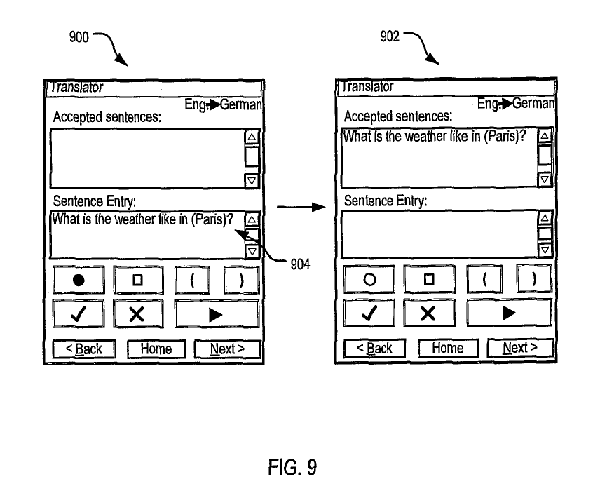

With reference now to FIG. 9 there is shown an example of a sequence of input interface screen displays 900, 902 of a source language phrase 904 which has been entered as a partitioned phrase, of the type described earlier, into a device 200 of the type described in relation to FIG. 2.

In this example, the entered source language phrase 904 comprises the partial or incomplete phrase source language element “What is the weather like in” and a word source language element, in the form of a noun, identified in closed brackets as “Paris”.

In this example the user 112 inputs the first section (that is, “What is the weather like in”) of the entered source language phrase 904 and then activates the “insert” controls 516 (ref. FIG. 5) and enters the second section (that is, “Paris”) of the source language phrase. In other words, the user 112 enters a source language phrase including one or more markers identifying a partitioned source language element in the source language phrase. Thus in this example the entered source language phrase comprises plural sections, with the first section being an unmarked section, and the second section being a marked section denoted by closed brackets.

After completing entry of the source language phrase, the device 200 selects a stored source language element having a correlation with the first section from the database 204 using the process described earlier in relation to FIG. 2. In other words, the device 200 selects the closest matching source language element from the database 204.

In relation to the second section, either the closest matching input from the database 202 is selected by the device 200 or the audio recording of the user's 112 speech input is stored for later replay. In the event that the device is unable to locate a stored storage language element having a suitable correlation with the second section, the response of the device 200 may vary according to whether the source language phrase was by entered as a keyed input or a speech input. For example, for a keyed entry, and in the event that no “close” match is located for the second section, the device 200 will prompt the user, after the complete source language phrase has been entered, to “verbally record the bracketed insert” or similar. After the second section has been verbally entered by the user, the first display area 502 will then display, for acceptance by the user, the source language element selected for the first section of the partitioned source language phrase together with an indication that the second section is in the form as entered by the user.

On the other hand, for a speech input, if a “close” match is not located for the second section, the device 200 will automatically store the speech input entered as the second section as an audio recording in a suitable form and, after the complete source language phrase has been entered, display, for acceptance by the user, the source language element selected for the first section of the partitioned source language phrase together with an indication that the second section is in the form as entered by the user.

### Example 4

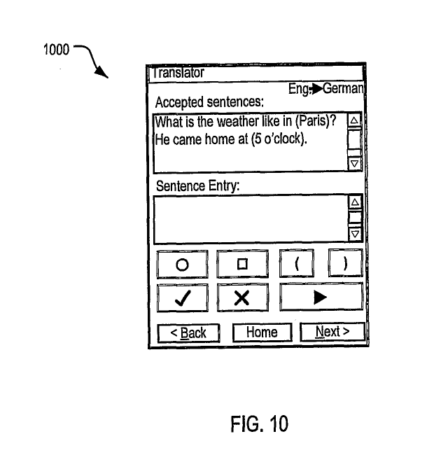

FIG. 10 depicts an example of a input interface 1000 in which plural stored source language phrase have been accepted as partitioned source language phrases by repeating the process described in relation to FIG. 9 for the additional source language phrase “He came home at [5 o'clock]”.

In this example, on activation of the “play control” 514 (ref. FIG. 5) by the user 112, the device 200 (ref. FIG. 2) outputs, in order of acceptance of accepted source language phrases, target language phrases encoded by the audio file objects associated with each section of the accepted source language phrases as the target language message.

By way of example, in German language “He came home [5o'clock]” is output as the target language message “Er kam um (5Uhr) nach Hause”. In other words, in this example the target language element output for the “insert” [5 o'clock] is located between two target language element outputs having a predefined association with the remainder of the accepted source language input.

The previous description of preferred embodiments and examples is provided to enable a skilled person to make or use the present invention. Various modifications to these embodiments will be readily apparent to a skilled reader. Thus the present invention is not intended to be limited to the embodiments shown and described herein.

1-36. (canceled)

37. A device for converting a source language message into a target language message, the device including: a first input for receiving separately entered source language phrases as the source language message for a user; a controller including a selector module and a message constructor module, the selector module for selecting, for each entered source language phrase, a stored source language phrase having a correlation with a respective entered source language phrase, each stored source language phrase having a predefined association with an object encoding a target language phrase; and a second input for receiving, for each selected source language phrase, an input indication of the user's acceptance of the selected source language phrase as an accepted source language phrase;
wherein the message constructor module constructs the target language message for output as a signal communicating a sequential arrangement of the target language phrases encoded by the objects associated with the accepted source language phrases.

38. A device according to claim 37 further including a device memory storing a library of stored source language phrases available for selection by the controller to select the stored source language phrase having a correlation with a respective entered source language.

39. A device according to claim 38 wherein the library contains stored source language phrases for plural different source languages, and wherein the device includes a source language selector which is operable by the user to select the source language for the source language message.

40. A device according to claim 38 wherein the library includes an indexable database.

41. A device according to claim 40 wherein a different indexable database is provided for each of plural different source languages, and wherein the device includes a source language selector which is operable by the user to select the source language for the source language message, and wherein the selection of the source language configures the device to index the indexable database for the selected source language.

42. A device according to claim 37 wherein for each entered source language phrase the correlation is determined as a value of correlation obtained from comparing elements of the entered source language phrase with corresponding elements of the stored source language phrases.

43. A device according to claim 42 wherein the elements include words or characters.

44. A device according to claim 37 further including a communications transceiver in communications with an external data storage device storing a library of stored source language phrases available for selection by the controller.

45. A device according to claim 44 wherein the library includes an indexable database.

46. A device .according to claim 45 wherein selecting a stored source language phrase for an entered source language phrase includes receiving from the external memory device the stored source language phrase having a correlation with the respective entered source language phrase.

47. A device according to claim 37 wherein the objects include audio file objects.

48. A device according to claim 47 wherein the sequential arrangement comprises a queue of the audio file objects associated with the accepted source language phrases.

49. A device according to claim 37 wherein the objects include text file objects.

50. A device according to claim 37 wherein the input permits the user to enter one or more of the entered source language phrases as a partitioned source language phrase including one or more markers identifying partitions segregating source language elements, and wherein the controller further includes means for selecting, for each source language element of a partitioned source language phrase, a stored source language element having a correlation with the source language element, each stored language element having a predefined association with an object encoding a target language element for inclusion in the sequential arrangement.

51. A device according to claim 50 wherein the device stores each entered segregated source language element as an object encoding the segregated source language element, and wherein, for each segregated source language element, if the device is unable to select a stored source language element having a correlation with an entered segregated source language element the device includes the stored object in the sequential arrangement.

52. A device according to claim 37 further including means for interchanging the source language and the target language after output of the target language message.

53. A device according to claim 37 wherein the signal is an audio signal for audible communication to another user.

54. A device according to claim 37 wherein the signal is a text signal for display to another user.

55. A device according to claim 37 wherein the signal is an electronic signal for communication to another device capable of receiving the electronic signal.

56. A method of converting a source language message into a target language using a device including a first input, a controller, and a second input, the method including:
separately entering source language phrases into the first input as the source language message for a user; the controller selecting, for each entered source language phrase, a stored source language phrase having a correlation with a respective entered source language phrase, each stored source language phrase having a predefined association with an object encoding a target language phrase; the second input receiving, for each selected source language phrase, an input indication of the user's acceptance of the selected source language phrase as an accepted source language phrase; and the controller constructing the target language message for output as a signal communicating a sequential arrangement of the target language phrases encoded by the objects associated with the accepted stored source language phrases.

57. A method according to claim 56 wherein selecting a stored source language phrase for an entered source language phrase includes selecting the stored source language phrase having a correlation with the entered source language phrase from a library in a memory location local to the device.

58. A method according to claim 56 wherein selecting a stored source language phrase for an entered source language phrase includes receiving the stored source language phrase having a correlation with the entered source language phrase from a library in a memory location external to the device.

59. A method according to claim 56 wherein the objects include audio file objects.

60. A method according to claim 59 wherein the sequential arrangement comprises a queue of the audio file objects associated with the obtained source language phrases.

61. A method according to claim 56 wherein the objects include text file objects.

62. A method according to claim 56 further including entering one or more of the entered source language phrases as a partitioned source language phrase including one or more markers identifying partitions segregating source language elements, and selecting, for each source language element of a partitioned source language phrase, a stored source language element having a correlation with the source language element, each stored language element having a predefined association with an object encoding a target language element for inclusion in the sequential arrangement.

63. A method according to claim 62 wherein the device stores each entered segregated source language element as an object encoding the segregated source language element, and wherein, for each segregated source language element, if the device is unable to select a stored source language element having a correlation with an entered segregated source language element the device includes the stored object in the sequential arrangement.

64. A method according to claim 56 further including interchanging the source language and the target language after output of the target language message.

65. A computer software readable media including computer program instructions which are executable by a device for converting a source language message into a target language message to cause the device to: receive separately entered source language phrases as the source language message for a user; select, for each entered source language phrase, a stored source language phrase having a correlation with a respective entered source language phrase, each stored source language phrase having a predefined association with an object encoding a target language phrase; receive, for each selected source language phrase, an input indication of the user's acceptance of the selected source language phrase as an accepted source language phrase;
construct the target language message for output as a signal communicating a sequential arrangement of the target language phrases encoded by the objects associated with the accepted stored source language phrases. output the target language message.

66. A device for converting a source language message into a target language message, the device including: a first input for receiving the source language message, the source language message comprising one or more partitioned source language phrases, each partitioned source language phrase including one or more markers identifying partitions segregating source language elements of the source language phrase; a controller: selecting for each source language element, a stored source language element having a correlation with each respective entered source language element, each stored language element having a predefined association with an object encoding a target language element; for each partitioned source language phrase constructing a source language phrase including the respective selected stored source language elements; and an output for outputting the target language message as a signal communicating a sequential arrangement of the target language elements encoded by the objects associated with the selected stored source language elements of the constructed source language phrase.

67. A device according to claim 66 further including means for interchanging the source language and the target language after output of the target language message.

68. A method of converting a source language message into a target language message, the method including: a device receiving the source language message, the source language message comprising one or more partitioned source language phrases, each partitioned source language phrase including one or more markers identifying partitions segregating source language elements of the source language phrase; the device: selecting for each source language element, a stored source language element having a correlation with each respective entered source language element, each stored language element having a predefined association with an object encoding a target language element; for each partitioned source language phrase constructing a source language phrase including the respective selected stored source language elements; and outputting the target language message as a signal communicating a sequential arrangement of the target language elements encoded by the objects associated with the selected stored source language elements of the constructed source language phrase.

69. A method according to claim 68 further including interchanging the source language and the target language after output of the target language message.
